(19) United States
(12) Patent Application Publication
(10) Pub. No.: US 2025/0339818 A1
(43) Pub. Date: Nov. 6, 2025

(54) METHOD AND SYSTEM FOR REMOVING OXYGEN FROM A CARBON DIOXIDE STREAM

(71) Applicant: NUOVO PIGNONE TECNOLOGIE - S.R.L., Florence (IT)

(72) Inventor: Reinhard BRACK, Frankfurt, Hesse (DE)

(21) Appl. No.: 18/855,551

(22) PCT Filed: Apr. 10, 2023
(86) PCT No.: PCT/EP2023/025167

§ 371 Date: Oct. 9, 2024

(30) Foreign Application Priority Data
Apr. 14, 2022 (IT) 102022000007412
Apr. 4, 2023 (IT) 102023000006633

(51) Int. Cl. B01D 53/86; C25B 1/04; C25B 9/05; C25B 15/08

(52) U.S. Cl. CPC B01D 53/8671; C25B 1/04; C25B 9/05; C25B 15/081; B01D 2251/202; B01D 2256/22; B01D 2257/104

(57) ABSTRACT

The method includes a step of compressing a gaseous oxygen-containing carbon dioxide stream and increasing the temperature thereof through compression, and a step of feeding the compressed and heated oxygen-containing carbon dioxide stream through an oxygen removal package and remove oxygen therefrom, such that the temperature achieved by compression is used for promoting an oxygen removal reaction in the oxygen removal package. The carbon dioxide stream, wherefrom oxygen has been removed, is then cooled for further processing. Further disclosed is a system for performing the above outlined method.

### TECHNICAL FIELD

The present disclosure concerns methods and systems for enhanced removal of oxygen from a stream of carbon dioxide.

### BACKGROUND ART

Carbon dioxide is produced by several human industrial activities, such as, among others, power generation by combustion of fossil fuels. Carbon dioxide is one of the greenhouse gases responsible for climate changes linked to global warming.

In an attempt to reduce the adverse environmental impact of greenhouse gas, systems and methods have been developed for carbon capture and storage (CCS), in order to reduce CO₂ emissions. Captured carbon dioxide is usually transported in pipelines or tanks. Carbon dioxide must be processed to meet transportation regulations and must be compressed before it can be used for pipeline transportation or liquefaction and transportation in tanks. Water and other impurities, such as oxygen, must be removed from the carbon dioxide, to avoid corrosion during transportation. Oxygen removal packages are used for that purpose. In known systems, the oxygen-containing carbon dioxide stream is processed in the oxygen removal package under heated conditions. Heating requires a large amount of energy and makes the whole process energy-consuming and inefficient.

A method and system aimed at reducing the amount of energy required to remove oxygen from a carbon dioxide stream and making the process more effective and more efficient would therefore be welcomed in the art.

### SUMMARY

According to one aspect, disclosed herein is a method for removing oxygen from a gaseous stream of carbon dioxide.

In embodiments disclosed herein, the method comprises a step of compressing a gaseous oxygen-containing carbon dioxide stream and heating said stream to a reaction temperature by compression. The required reaction temperature is achieved by effect of conversion of mechanical power into heat in the carbon dioxide compressor without the need of supplying additional power, e.g. from an electric heater. This results in a substantial energy saving.

The method further includes the step of providing a flow of high-pressure hydrogen generated by a high-pressure electrolyser. As understood herein, a “high-pressure electrolyser” is an electrolyser adapted to generate hydrogen at a pressure equal to or higher than 20 barg, in some embodiments equal to or higher than 30 barg. As understood herein “high-pressure hydrogen” generated by electrolysis is hydrogen at a pressure equal to or higher than 20 barg, in some embodiments equal to or higher than 30 barg. The use of a high-pressure electrolyser results in additional energy saving. The high-pressure electrolyser can include an alkaline electrolyser, or a polymer electrolyte membrane (PEM) electrolyser, for instance.

The high-pressure hydrogen generated by the high-pressure electrolyser and the compressed and heated oxygen-containing carbon dioxide stream are fed to an oxygen removal package, e.g. a catalytic oxidation reactor (CATOX reactor), where hydrogen and oxygen contained in the oxygen-containing carbon dioxide stream are reacted so as to remove oxygen from the oxygen-containing carbon dioxide stream. The resulting carbon dioxide stream, substantially free of oxygen, can be cooled prior to be further processed, e.g. cooled and liquefied, for storage or transportation purposes.

In practice, the temperature of the oxygen-containing carbon dioxide stream, which has been achieved by compression, is used for promoting an oxygen removal reaction in the oxygen removal package.

In some embodiments, the oxygen removal package is adapted to operate at a temperature equal to or below 150° C., or equal to or below 120° C. For instance, the oxygen removal package can operate between 80° C. and 150° C., or between 80° C. and 120° C., for instance between 100° C. and 120° C. The oxygen removal package can further operate at a pressure between 20 and 60 barg, for instance between 20 and 55 barg, or between 20 barg and 45 barg.

An intercooled compressor, conventionally used to compress the oxygen-containing carbon dioxide stream, achieves an output temperature around 120° C., for instance. The method disclosed herein can therefore operate with a conventional inter-cooled compressor, without the need to deliver further thermal power to the compressed oxygen-containing carbon dioxide stream and without the need to remove the intercooler, therefore maintaining high compression efficiency.

The oxygen-containing carbon dioxide stream can be delivered to the catalytic oxidation reactor from the delivery side of a compressor or compressor train, i.e. once the final pressure of the carbon dioxide stream has been achieved. The option, however, is not excluded to process the oxygen-containing carbon dioxide stream before the final pressure is achieved. I.e., the oxygen-containing carbon dioxide stream can be partly compressed, processed in the catalytic oxidation reactor for oxygen removal therefrom, and subsequently further compressed to the final pressure required for transportation, storage and/or liquefaction.

For instance, the oxygen-containing carbon dioxide stream can be processed through the catalytic oxidation reactor after partial compression in one or more compressor stages or compressors, optionally intercooled and arranged in sequence. In this case, the oxygen-free carbon dioxide stream from the catalytic oxidation reactor can be further compressed to the required final pressure.

In some embodiments, hydrogen generated by high-pressure electrolysis can be further compressed up to a suitable pressure, higher than the hydrogen delivery pressure of the high-pressure electrolyser. The hydrogen can be heated further at a suitable temperature, before being fed into the catalytic oxidation reactor.

In some embodiments, the hydrogen compression can be performed in a static compression unit, i.e. a device having no moving mechanical parts.

In some embodiments the hydrogen generated by the high-pressure electrolyser can be compressed through a metal hydride absorption and desorption process. The final temperature and pressure at which the compressed hydrogen is delivered by the metal hydride absorption and desorption process can be suitable for direct feeding to the catalytic oxidation reactor.

If heating of the hydrogen through the metal hydride absorption and desorption process is not sufficient, specifically in transient conditions, and the catalytic oxidation reactor requires additional thermal energy, the latter can be provided by a heater, for instance an electric heater. An external heater can specifically be used at start-up.

According to another aspect, disclosed herein is a system for removing oxygen from an oxygen-containing carbon dioxide stream. The system comprises a carbon-dioxide compressor and an oxygen removal package, such as a catalytic oxidation reactor, fluidly coupled to the carbon dioxide compressor. The system further comprises a high-pressure electrolyser adapted to generate hydrogen at high pressure, i.e. at or above 20 barg, for instance at or above 30 barg. The electrolyser is fluidly coupled to the catalytic oxidation reactor and adapted to feed hydrogen to the catalytic oxidation reactor. The catalytic oxidation reactor is adapted to cause an oxidation reaction of the hydrogen with the oxygen contained in the compressed carbon dioxide stream. The carbon-dioxide compressor can be an intercooled compressor. The carbon dioxide compressor is adapted to deliver a compressed stream of oxygen-containing carbon dioxide at a temperature adapted to be reacted with hydrogen in the oxygen removal package, for instance at a temperature between 80° C. and 150° C., or between 80° C. and 120°, for instance between 100° C. and 120°.

In use, the oxygen removal package is adapted to receive oxygen-containing carbon dioxide stream at a reaction temperature achieved by compression in the carbon-dioxide compressor and suitable for reacting the oxygen with the hydrogen generated by the high-pressure electrolyser.

The system can further include a cooler downstream of the catalytic oxidation reactor, adapted to cool the carbon dioxide stream after oxygen removal therefrom through the catalytic oxidation reactor.

The system can further include a metal hydride compression and storage unit adapted to further compress the hydrogen generated by the high-pressure electrolyser. The metal hydride compression unit also increases the temperature of the hydrogen.

Further features and embodiments of methods and systems according to the present disclosure are described below reference being made to the attached drawings, and are set forth in the appended claims.

### BRIEF DESCRIPTION OF THE DRAWINGS

Reference is now made briefly to the accompanying drawings, in which:

FIG. 1 illustrates a schematic of a system according to the present disclosure; and

FIG. 2 illustrates a flowchart summarizing a method according to the present disclosure.

### DETAILED DESCRIPTION

In short, a gaseous stream of oxygen-containing carbon dioxide is processed in a compressor prior to cooling and transportation. The temperature of the carbon dioxide stream is increased by compression and the heat thus generated is used to operate an oxygen removal package at suitable operating temperature, without the need to supply large amounts of thermal power from external sources. An efficient system is thus obtained, which reduces overall power consumption and increases efficiency of the process.

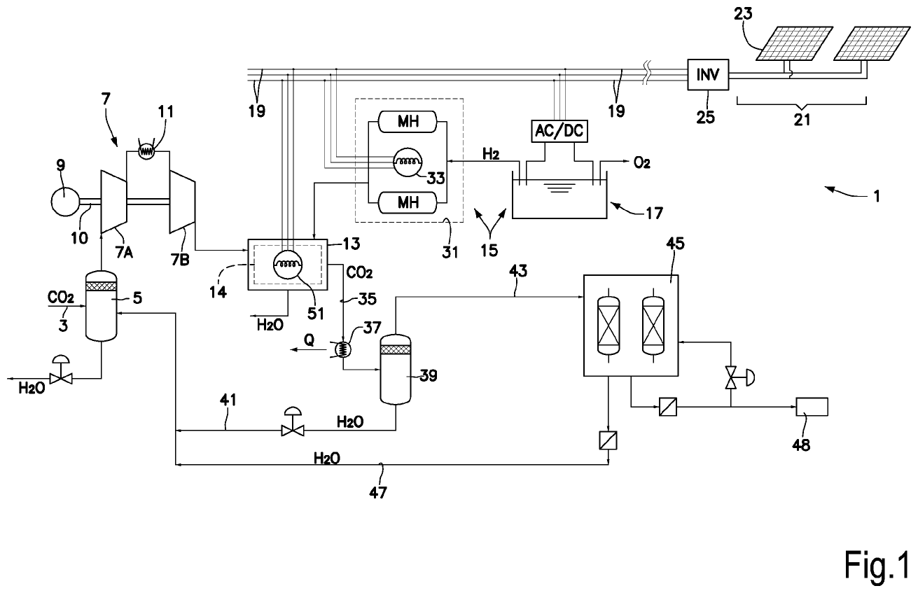

Turning now to the drawings, FIG. 1 illustrates a schematic of a system 1 for processing a gaseous stream of oxygen-containing carbon dioxide, wherefrom oxygen shall be removed prior to transportation, storage or other operations.

The oxygen-containing carbon dioxide stream is delivered along an inlet line 3 and may be provided by any facility upstream, not shown, such as a chilled ammonia process system, which captures carbon dioxide from flue gas produced by a gas turbine, for instance. The system further includes a first gas/water separator 5, where water contained in the carbon dioxide stream flowing through the inlet line 3 is removed.

The system 1 further comprises a carbon dioxide compressor 7. In actual fact the carbon dioxide compressor 7 can include one or more compressors or compressor stages, which may be driven by one or more drivers 9 through one or more shafts 10. In the schematic of FIG. 1 the compressor 7 is represented as a two-stage compressor including a first compressor, or compressor stage 7A and a second compressor, or compressor stage 7B. An intercooler 11 can be provided between the first compressor, or compressor stage 7A and the second compressor, or compressor stage 7B.

The delivery side of the carbon dioxide compressor 7 is fluidly coupled to an oxygen removal package 13, which may include a catalytic oxidation reactor (shortly CATOX) 14, where oxygen is removed from the carbon dioxide stream by catalytically reacting the oxygen with a reaction gas, specifically hydrogen. In embodiments disclosed herein, the reaction gas is or includes hydrogen delivered to the oxygen removal package 13 by a hydrogen source, generically shown at 15. An embodiment of a suitable hydrogen source will be described herein below.

The oxidation reaction in the catalytic oxidation reactor 13 is performed at an oxidation pressure, also referred herein as reaction pressure, above ambient pressure and at an oxidation temperature, also referred herein a reaction temperature, above ambient temperature.

When the reaction gas is hydrogen, the oxidation pressure can be between 20 and 60 barg, for instance between 20 and 55 barg, or between 20 barg and 45 barg. The oxidation temperature can be above 80° C., for instance between 80° C. and 150° C., or between 80° C. and 120° C., e.g. between 100° C. and 120° C.

In some embodiments, the carbon dioxide compressor 7 is configured and controlled to deliver a stream of compressed, oxygen-containing carbon dioxide which, once entering the catalytic oxidation reactor 14, is at the required oxidation pressure and oxidation temperature, without the need for exogenous heating, i.e. without requiring additional thermal power to be delivered to the carbon dioxide stream. For instance, the oxygen-containing carbon dioxide stream can be at a pressure between 20 and 60 barg, for instance between 20 and 55 barg, or between 20 barg and 45 barg. The temperature of the oxygen-containing carbon dioxide stream can be comprised between 80° C. and 150° C., or between 80° C. and 120° C., for instance between 100° C. and 120° C. A standard intercooled centrifugal compressor system can be used to achieve these temperature and pressure ranges.

In the embodiment of FIG. 1 the hydrogen source 15 comprises an electrolyser 17 powered by electric power from an electric power distribution grid 19. In some embodiments, the electrolyser 17 is a high-pressure electrolyser.

Hydrogen generated by the electrolyser can be at a pressure equal to or higher than 20 barg, for example equal to or higher than 30 barg.

The electric power for the electrolyser can be provided by a power generator 21 using a renewable energy resource. In the embodiment of FIG. 1 the power generator 21 comprises photovoltaic panels 23 and an inverter 25, which converts solar power into AC electric power.

The electric power is delivered to the electric power distribution grid 19 and supplied to the electrolyser 17 through an AC/DC converter, and possibly other utilities, as will be explained later on. In other embodiments, DC electric power generated by the photovoltaic panels can be directly used to power the electrolyser, without prior DC/AC conversion.

Other renewable energy resources can be used, such as wind, through a wind farm, or the like. The use of an electric generator using a hydraulic turbine, a vapor turbine or a gas turbine or a combination thereof, possibly in combination with renewable energy resources, is not excluded.

The electrolyser 17 produces hydrogen at a pressure and temperature which may be insufficient for reaction with the oxygen in the catalytic oxidation reactor 13. For instance, the electrolyser 17 can be a high-pressure electrolyser generating hydrogen at 20 barg or higher, for instance at 30 barg or higher. The outlet hydrogen temperature can be comprised between 50° C. and 80° C., for instance around 65° C. and 75° C.

If the pressure and/or the temperature of the hydrogen generated by the electrolyser 17 are insufficient, devices to increase the hydrogen pressure and/or the hydrogen temperature can be used.

In some embodiments, to boost the hydrogen pressure and increase the temperature thereof, a reciprocating or a dynamic compressor can be used, possibly in combination with a heater, such as an electric heater.

In some embodiments, however, the pressure and temperature of the hydrogen delivered by the electrolyser 17 are increased using a metal hydride absorption and desorption process, using a metal hydride compression and storage unit 31.

As known from the art of hydrogen processing and storage, a metal hydride compression and storage unit is a static compression system, wherein hydrogen molecules (H₂) are split into hydrogen atoms (H), which are absorbed in the interstitial spaces of a metal alloy. The thermodynamic properties of the metal hydride material are used to compress hydrogen and store the hydrogen until subsequent release (desorption) at a higher pressure. The absorption process releases heat, while a subsequent desorption phase requires heat to release hydrogen from the metal alloy at a pressure higher than the initial pressure at which the hydrogen has been delivered to the metal alloy for absorption therein. More details on the application of hydrides for hydrogen storage and compression are to be found in: Jose Bellosta von Colbe, et al, in “Application of Hydrides in Hydrogen Storage and Compression: Achievements, Outlook and Perspectives”, in International Journal of Hydrogen Energy 44 (2019) 7780-7808, available online at www.sciencedirect.com. A hydrogen storage system using metal hydrides is disclosed in EP3726124, for instance.

Heat for operating the metal hydrides compression and storage unit 31 can be provided by electric power from the electric power distribution grid 19, through a heater 33, if needed.

The oxygen removal package 11 can be fluidly coupled through a line which delivers the oxygen-free carbon dioxide stream from the oxygen removal package 11 to a cooler 37, which removes heat from the carbon dioxide stream. The outlet side of the cooler 37 can be fluidly coupled to a second gas/water separator 39. The water outlet of the gas/water separator 39 can be fluidly coupled to the first gas/water separator 5 through a return line 41. The gas outlet of the second gas/water separator 39 can be fluidly coupled through a line 43 to a dryer 45. Water from the dryer 45 can be returned through a return line 47 to the first gas/water separator 5 and the chilled and dried carbon dioxide stream can be further delivered to a processing unit 48, for instance to a pipeline or a liquefaction unit.

The above-described system is capable of processing the oxygen-containing carbon dioxide stream in an efficient manner, reducing the amount of energy required to operate the oxygen removal package, since the carbon dioxide stream is heated by compression through the carbon dioxide compressor 7. Static hydrogen compression system using the metal hydride compression and storage unit 31 optimizes the hydrogen compression and heating process, as the heat generated during hydrogen absorption in the metal alloy is exploited during the hydrogen desorption at higher pressure from the metal alloy.

During operation in steady state operating conditions the temperature of the catalytic oxidation reactor 13 is sufficient to prevent water vapor contained in the carbon dioxide stream from condensing in the catalytic oxidation reactor, which would damage the catalyst contained therein.

In order to avoid water condensation in the catalytic oxidation reactor 13 at start-up, in some embodiments the catalytic oxidation reactor 13 can be provided with a heater 51 adapted to pre-heat the reactor mass and catalyst material. The heater 51 can be, for instance, an electric heater that can be powered by the electric power distribution grid 19.

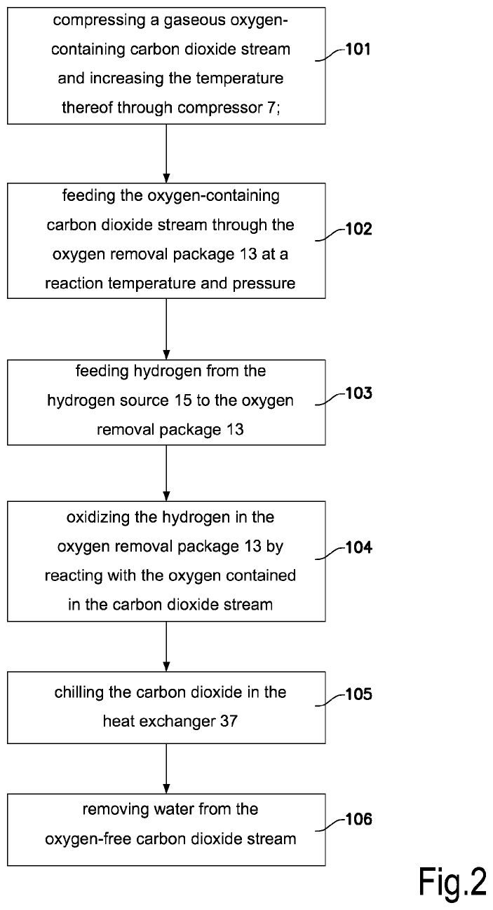

The method for oxygen removal from carbon dioxide stream performed by the system 1 is summarized in the flowchart of FIG. 2. The flowchart shows the following steps: compressing a gaseous oxygen-containing carbon dioxide stream and increasing the temperature thereof through compressor 7 (step 101); feeding the oxygen-containing carbon dioxide stream, at required reaction temperature and pressure, through the catalytic oxidation reactor 13 (step 102); feeding hydrogen from the hydrogen source 15 to the catalytic oxidation reactor 13 (step 103); oxidizing the hydrogen in the catalytic oxidation reactor 13 by reacting with the oxygen contained in the carbon dioxide stream (step 104); chilling the carbon dioxide in the heat exchanger 37 (step 105); and finally removing water from the oxygen-free carbon dioxide stream (step 106).

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A method for removing oxygen from a gaseous stream of carbon dioxide, the method comprising the following steps:
compressing a gaseous oxygen-containing carbon dioxide stream and heating the oxygen-containing carbon dioxide stream through compression up to an oxidation-reaction temperature;
generating a hydrogen in a high-pressure electrolyser;
feeding the hydrogen and the compressed and heated oxygen-containing carbon dioxide stream to an oxygen removal package;
reacting hydrogen and oxygen of the oxygen-containing carbon dioxide stream in the oxygen removal package and removing therewith oxygen from the oxygen-containing carbon dioxide stream; and
cooling the carbon dioxide stream released from the oxygen removal package.

2. The method of claim 1, wherein the oxygen removal package comprises a catalytic oxidation reactor.

3. The method of claim 1, wherein hydrogen generated by the high-pressure electrolyser is further compressed and heated upstream of the oxygen removal package.

4. The method of claim 3, wherein the hydrogen is further compressed and heated up to an oxidation temperature and oxidation pressure through metal hydride absorption and desorption.

5. The method of claim 1, wherein the oxygen-containing carbon dioxide stream is heated by compression at a temperature between 80° C. and 150° C., or between 80° C. and 120° C., or between 100° C. and 120° C.; and wherein the step of reacting hydrogen and oxygen in the oxygen removal package is performed at a reaction temperature between 80° C. and 150° C., or between 80° C. and 120° C., or between 100° C. and 120° C.

6. The method of claim 1, wherein the oxygen-containing carbon dioxide stream is fed to the oxygen removal package at a pressure comprised between 20 barg and 60 barg, or between 20 barg and 55 barg.

7. The method of claim 1, wherein the step of compressing the gaseous oxygen-containing carbon dioxide stream is performed in an intercooled compressor.

8. A system for removing oxygen from a gaseous oxygen-containing carbon dioxide stream, the system comprising:
a carbon-dioxide compressor;
an oxygen removal package, fluidly coupled to the carbon dioxide compressor;
a high-pressure electrolyser adapted to feed hydrogen to the oxygen removal package;
wherein, in use, the oxygen removal package is adapted to receive oxygen-containing carbon dioxide stream from the carbon-dioxide compressor at a reaction temperature and at a reaction pressure achieved by compression in the carbon-dioxide compressor, and hydrogen generated from the high-pressure electrolyser.

9. The system of claim 8, further comprising a cooler downstream of the oxygen removal package, adapted to receive the carbon dioxide stream from the oxygen removal package after oxygen removal therefrom.

10. The system of claim 8, wherein the oxygen removal package comprises a catalytic oxidation reactor.

11. The system of claim 8, further comprising a metal hydride compression and storage unit adapted to receive hydrogen from the high-pressure electrolyser and feed compressed and heated hydrogen to the oxygen removal package.

12. The system of claim 11, further comprising a heater for heating the metal hydride compression and storage unit, in particular at start-up.

13. The system of claim 8, wherein the oxygen removal package is adapted to operate at an oxidizing pressure between 20 and 60 barg, for instance between 20 and 55 barg, or between 20 barg and 45 barg.

14. The system of claim 8, wherein the oxygen removal package is adapt to operate at an oxidizing temperature between 80° C. and 150° C., or between 100° C. and 120° C.

15. The system of claim 8, further comprising a heater for heating the oxygen removal package at start-up.

16. The system of claim 8, wherein the carbon dioxide compressor is an intercooled compressor comprising a first compressor stage, a second compressor stage and an intercooler therebetween.
